(19) United States
(12) Patent Application Publication
(10) Pub. No.: US 2017/0109435 A1
(43) Pub. Date: Apr. 20, 2017

(54) APPARATUS AND METHOD FOR SEARCHING FOR INFORMATION

(71) Applicant: Hisense Co., Ltd., Qingdao (CN)

(72) Inventor: Jinkai LI, Qingdao (CN)

(21) Appl. No.: 15/393,654

(22) Filed: Dec. 29, 2016

(30) Foreign Application Priority Data
Jul. 15, 2016 (CN) 201610562499.4

(51) Int. Cl. G06F 17/30

(52) U.S. Cl. CPC G06F 17/30684; G06F 17/30663

(57) ABSTRACT

The disclosure discloses an apparatus and method for searching for information so as to avoid the accuracy of the search from being degraded due to a loss of information. The method includes: receiving an interactive sentence for searching for information; determining a target semantic attribute template from a set of semantic attribute templates, where the target semantic attribute template is a semantic attribute template including semantic attributes corresponding respectively to semantic attributes of a plurality of consecutive words in the interactive sentence, and the set of semantic attribute templates includes at least one semantic attribute template including multiple semantic attributes in sequence or one semantic attribute; determining a phrase including a plurality of consecutive words matching the target semantic attribute template as a single-query condition of the interactive sentence; and searching for information according to the single-query condition.

### CROSS-REFERENCE TO RELATED APPLICATION

This application claims the benefit and priority of Chinese Patent Application No. 201610562499.4 filed Jul. 15, 2016. The entire disclosure of the above application is incorporated herein by reference.

### FIELD

The present disclosure relates to the field of Internet technologies, and particularly to an apparatus and method for searching for information.

### BACKGROUND

This section provides background information related to the present disclosure which is not necessarily prior art.

As the Internet technologies are developing constantly, and there are a growing variety of network data, in order to enable a user to retrieve his or her desirable information rapidly from a tremendous amount of network data, the user can be provided with a search service in which the user can input a sentence in a search box, so that the tremendous amount of network data are searched for the related information according to the sentence input by the user.

In the related technologies, the information can be searched by obtaining the sentence input by the user, extracting keywords from the sentence, and searching for the related information according to the extracted keywords; for example, if the sentence input by the user is “Movies directed by Xingchi ZHOU and starred by Mengda WU”, then keywords “Xingchi ZHOU, Mengda WU and Movies” will be extracted from the sentence, and the Internet will be searched according to the keywords to obtain a search result.

### SUMMARY

This section provides a general summary of the disclosure, and is not a comprehensive disclosure of its full scope or all of its features.

Embodiments of the disclosure provide an apparatus and method for searching for information in the following technical solutions:

In a first aspect, some embodiments of the disclosure provide an apparatus for searching for information, the apparatus including a memory configured to store computer readable program codes, and at least one processor configured to execute the computer readable program codes to perform:

receiving an interactive sentence for searching for information;

determining a target semantic attribute template from a set of semantic attribute templates, wherein the target semantic attribute template is a semantic attribute template including semantic attributes corresponding respectively to semantic attributes of a plurality of consecutive words in the interactive sentence, and the set of semantic attribute templates includes at least one semantic attribute template including multiple semantic attributes in sequence or one semantic attribute;

determining a phrase including a plurality of consecutive words matching the target semantic attribute template as a single-query condition of the interactive sentence; and

searching for information according to the single-query condition.

In a second aspect, some embodiments of the disclosure provide a method for searching for information, the method including:

receiving an interactive sentence for searching for information;

determining a target semantic attribute template from a set of semantic attribute templates, wherein the target semantic attribute template is a semantic attribute template including semantic attributes corresponding respectively to semantic attributes of a plurality of consecutive words in the interactive sentence, and the set of semantic attribute templates includes at least one semantic attribute template including multiple semantic attributes in sequence or one semantic attribute;

determining a phrase including a plurality of consecutive words matching the target semantic attribute template as a single-query condition of the interactive sentence; and

searching for information according to the single-query condition.

In a third aspect, some embodiments of the disclosure provide a nonvolatile computer storage medium storing computer executable instructions configured:

to receive an interactive sentence for searching for information;

to determine a target semantic attribute template from a set of semantic attribute templates, wherein the target semantic attribute template is a semantic attribute template including semantic attributes corresponding respectively to semantic attributes of a plurality of consecutive words in the interactive sentence, and the set of semantic attribute templates includes at least one semantic attribute template including multiple semantic attributes in sequence or one semantic attribute;

to determine a phrase including a plurality of consecutive words matching the target semantic attribute template as a single-query condition of the interactive sentence; and

to search for information according to the single-query condition.

Further aspects and areas of applicability will become apparent from the description provided herein. It should be understood that various aspects of this disclosure may be implemented individually or in combination with one or more other aspects. It should also be understood that the description and specific examples herein are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a flow chart of a method for searching for information according to some embodiments of the disclosure;

FIG. 2 is a flow chart of a method for determining a target semantic attribute template according to some embodiments of the disclosure;

FIG. 3 is a block diagram of an apparatus for searching for information according to some embodiments of the disclosure;

FIG. 4 is a block diagram of another apparatus for searching for information according to some embodiments of the disclosure; and

FIG. 5 is a schematic structural diagram of a terminal 400 according to some embodiments of the disclosure.

Corresponding reference numerals indicate corresponding parts or features throughout the several views of the drawings.

### DETAILED DESCRIPTION

Example embodiments will now be described more fully with reference to the accompanying drawings.

Various exemplary embodiments of the disclosure, examples of which are illustrated in the drawings, will be described below in details. The following description will be given with reference to the drawings throughout which like reference numbers refer to like or similar elements unless stated otherwise. The exemplary embodiments described below will not represent all the embodiments of the disclosure. On the contrary, they will be presented only as examples of the apparatus and the method according to some aspects of the disclosure as detailed in the appended claims.

Before the embodiments of the disclosure are described in details, firstly an application scenario of the embodiments of the disclosure will be introduced. The method according to the embodiments of the disclosure can be applicable to a smart device with a search function, or on which a search engine can be installed, including a TV set, a mobile phone, a computer, a tablet computer, etc. By way of an example, the method according to some embodiments of the disclosure can be applicable to such a TV set that is configured therein with a multimedia audio-video resource library which can be searched for a related movie, so that the TV set can search vertically the multimedia audio-video resource library for the title of or other information about a related audio-video resource, e.g., a movie, a teleplay, etc., according to an interactive sentence input by a user, to thereby satisfy a search demand of the user, where the vertical search refers to a professional search in some industry, and the method for searching for information according to the embodiments of the disclosure will be described taking the vertical search in the industry of film and television as an example; and the vertical search is more specialized, specific and profound than a general search made out of order among a tremendous amount of information. Of course, the vertical search in the industry of film and television will be described merely as an example, but the method for searching for information according to the embodiments of the disclosure will not be limited thereto.

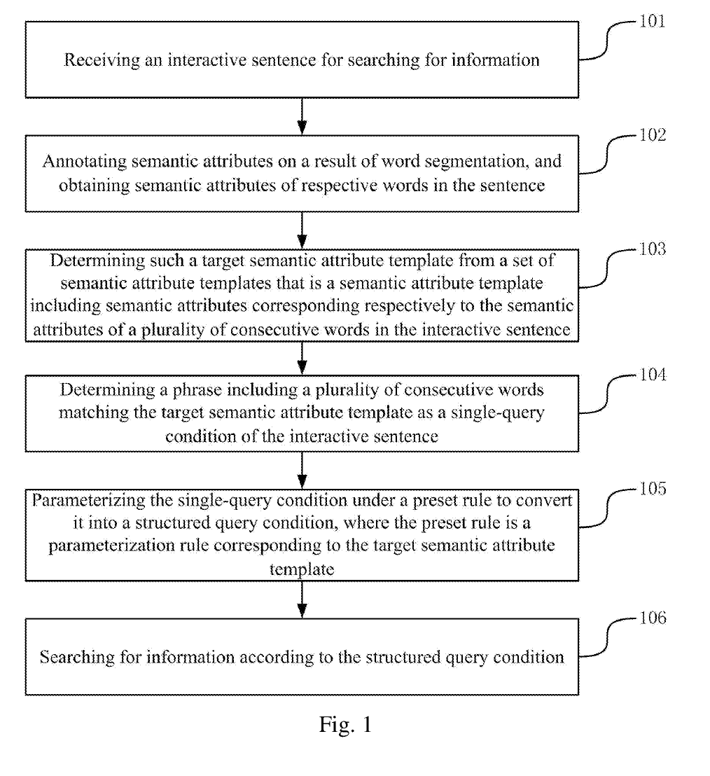

FIG. 1 is a flow chart of a method for searching for information according to some embodiments of the disclosure, which can be performed by a terminal with a function of searching for information, e.g., a TV set, a computer, a mobile phone, etc., where the method for searching for information according to some embodiments of the disclosure will be described below in details in an example of an disclosure scenario in which a multimedia audio-video resource library is searched for a movie or teleplay resource. As illustrated in FIG. 1, the method includes the following operations:

The operation 101 is to receive an interactive sentence for searching for information.

In some embodiments of the disclosure, the interactive sentence can be input by a user on a touch screen, or can be input by the user using a keyboard, or can be input by the user via speaking to a microphone, but the embodiments of the disclosure will not be limited to any particular mode in which the interactive sentence is input.

For example, the user inputs such information as “Movies after 1990's”, “Movies directed by Xingchi ZHOU and starred by Mengda WU”, etc., in a search box on a search page, and the terminal receives the information input by the user, where the information input by the user is the interactive sentence for searching for information; and furthermore the terminal converts the received information into an interactive sentence in the form of a carrier suitable for the terminal; but the embodiments of the disclosure will not be limited to any particular form of the interactive sentence.

The operation 102 is to annotate semantic attributes on a result of word segmentation, and to obtain semantic attributes of respective words in the sentence.

The result of word segmentation can be obtained by performing word segmentation process on the interactive sentence, where the word segmentation process on the sentence refers to the process that segmenting a sequence of consecutive Chinese characters or multiple English words into respective words. For the interactive sentence in Chinese, the word segmentation process can be performed based upon a dictionary, by matching with a word library, based upon a statistic of frequencies of words, or based upon knowledge understanding; or otherwise, but the embodiments of the disclosure will not be limited to any particular scheme to segment the sentence into words.

A semantic attribute characterizes a semantic characteristic category of some word, for example, the semantic attributes in the industry of film and television can include a movie title, an actor name, a director name, a number, a rank word, an episode unit, a verb, a date, a preposition, an auxiliary word, etc., and of course, there may be other semantic attributes, where the semantic characteristics can be categorized for an application scenario, but the embodiments of the disclosure will not be limited to any particular semantic attributes.

A semantic attribute is annotated by annotating the semantic attribute of each word in the result of word segmentation, where the semantic attribute can be annotated by annotating the semantic attribute of each word according to a set of semantic attribute templates, or the application scenario of the method according to the embodiments of the disclosure, or the field to which the method relates. In the embodiments of the disclosure, the field to which the method relates is the field of film and television, that is, the annotation process will be described in details by way of an example in which the database is a multimedia audio and video resource library. If the interactive sentence is “Movies directed by Xingchi ZHOU and starred by Mengda WU”, then semantic attributes will be annotated on the result of word segmentation, thus resulting in “Movies (multimedia type (Movies))/directed (verb)/by (preposition)/Xingchi ZHOU (director name)/and (conjunction)/starred (verb)/by (preposition)/Mengda WU (actor name)”. Furthermore the part of speech of each word can be further annotated, for example, the part of speech of each word can be annotated as a noun, a verb, an adjective, or another part of speech.

It shall be noted that in the embodiments of the disclosure, the interactive sentence can be segmented into words, and semantic attributes can be annotated, in other schemes than the schemes above, but the embodiments of the disclosure will not be limited thereto.

The operation 103 is to determine a target semantic attribute template from a set of semantic attribute templates, where the target semantic attribute template is a semantic attribute template including semantic attributes corresponding respectively to the semantic attributes of a plurality of consecutive words in the interactive sentence, and the set of semantic attribute templates includes at least one semantic attribute template including multiple semantic attribute in sequence or one semantic attribute.

The set of semantic attribute templates includes at least one semantic attribute template, each of which includes multiple semantic attributes in sequence or one semantic attribute. In some embodiments of the disclosure, a corresponding relationship between the semantic attribute template and grammar semantic information is as depicted in Table 1 below:

TABLE 1

| Semantic attribute template | Grammar semantic information | Example |
|---|---|---|
| \hat{ }_?title_number_?$ | Movie title + Number | The Hobbit/3 |
| \hat{ }_?title_movieQuant_number_ ?$ | Movie title + Episode unit + | Goodbye Mr. Loser/ |
| | Number | season/4 |
| \hat{ }_?cast_actVerb_?$ | Actor name + Verb | Dehua LIU/stars |
| \hat{ }_?direct_directVerb_?$ | Director name + Verb | Zheng XU/directs |
| \hat{ }(_?(dateWords_)?year(_data | Date + Date unit + | 2000/year/before |
| Words)?)+_beforeWord_?$ | Preposition | |
| \hat{ }_?concert_(auxWord_)?_singer_?$ | Vocal concert + Auxiliary | vocal concert/of / |
| | word + Singer | Ziqi DENG |

In Table 1, the semantic attribute template “̂_?title_number_?$” includes the semantic attributes “title” and “number”, where “title” represents a movie title, and “number” represents a number, where the corresponding example is “The Hobbit/3”; the semantic attribute template “̂_?title_movieQuant_number_?$” includes the semantic attribute “movieQuant” representing an episode unit, e.g., “season”, “episode”, “part”, etc; the semantic attribute template “̂_?cast_actVerb_?$” includes the semantic attributes “cast” representing an actor name, “actVerb” representing a act-like verb, e.g., “star”, “portray”, etc.; the semantic attribute template “̂_?direct_directVerb_?$” includes the semantic attributes “direct” representing a director name, and “directVerb” representing a direct-like verb; the semantic attribute template “̂(_?(dateWords_)?year(_dateWords)?)+_beforeWord_?$” includes the semantic attributes “dateWords” representing a date word, and “beforeWord” representing a time preposition, e.g., “before”, “after”, etc.; and the semantic attribute template “̂_?concert_(auxWord_)?_singer_?$” includes the semantic attributes “auxWord” representing an auxiliary word and “singer” representing a singer name.

It shall be noted that Table 1 depicts only a part of the semantic attribute templates, that is, the set of semantic attribute templates includes other semantic attribute templates in addition to the semantic attribute templates illustrated in the table above; and moreover the semantic attribute templates depicted in Table 1 are only intended to illustrate the method for searching for information according to the embodiments of the disclosure, but the semantic attribute templates can alternatively be defined in other forms, and the embodiments of the disclosure will not be limited thereto.

The target semantic attribute template can be determined from the set of semantic attribute templates, for example, in a maximum forward template matching algorithm, a maximum reverse template matching algorithm, or a combination thereof, or in other algorithm, but the embodiments of the disclosure will not be limited thereto.

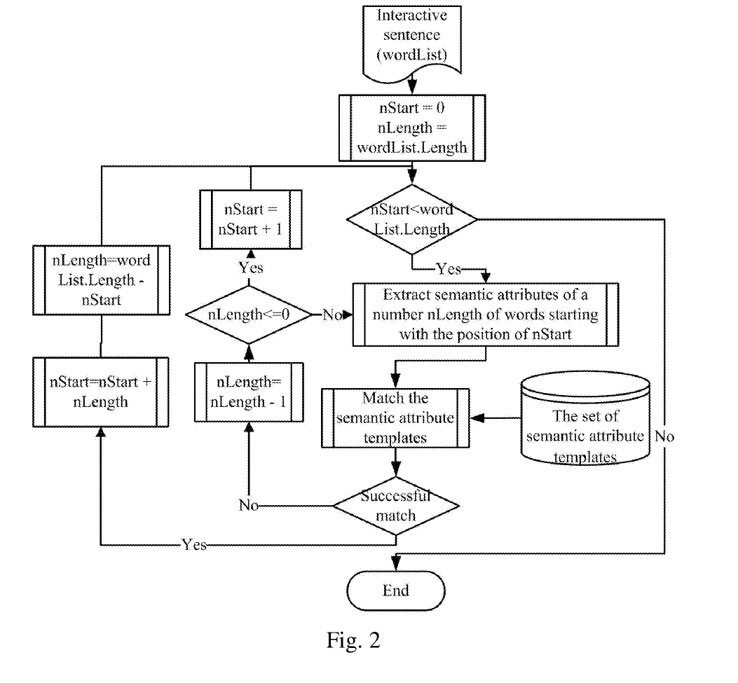

In some embodiments of the disclosure, the target semantic attribute template will be determined in the maximum forward template matching algorithm as described below by way of an example. FIG. 2 is a flow chart of a method for determining a target semantic attribute template according to some embodiments of the disclosure, where the method includes:

The value of wordlist. Length which represents the number of words into which the interactive sentence is segmented, is determined according to the result of word segmentation, and assigned to nLength, and a number nLength of Chinese characters in the interactive sentence are extracted starting with nStart=0, i.e., in the left-to-right order in the sentence, and matched with the respective semantic attribute templates in the set of semantic attribute templates; and if the matching is successful, then the semantic attribute template corresponding to the number nLength of Chinese characters will be determined as a target semantic attribute template, and also the value of nStart will be increased by nLength, and the value of nLength will be made equal to the length of remaining words which are not matched, i.e., nLength=wordList.Length-nStart; or if the matching is unsuccessful, then the parameter nLength will be decreased by 1, it will be determined whether nLength is less than or equal to 0, and if so, the operation of extracting a number nLength of Chinese characters in the interactive sentence in the left-to-right order in the sentence, and the subsequent operation of matching them will be repeated; otherwise, nStart will be increased by 1, and the operation of extracting a number nLength of Chinese characters in the sentence in the left-to-right order in the sentence, and the subsequent operation of matching them will be repeated starting with the second word in the sentence.

Taking an interactive sentence in Chinese for example, if the interactive sentence is “Dehua LIU zhuyan de dianying”, here the interactive sentence in Chinese is represented by chinese phonetic alphabet instead of Chinese characters, then semantic attributes will be annotated on a result of word segmentation, since “Dehua LIU” is both an actor name and a singer name, two annotation results of cast_actVerb_auxWord_videoType and singer_actVerb_auxWord_videoType will be obtained, that is, the “Dehua LIU” corresponds to the semantic attributes cast and singer, the “zhuyan” corresponds to the semantic attribute verb, the “de” corresponds to the semantic attribute duxiliary word, and the “dianying” corresponds to the semantic attribute multimedia type, and then target semantic attribute templates and subsequent search processes will be determined and made for the two annotation results above respectively in a search for information. In the embodiments of the disclosure, taking the annotation result as “cast_actVerb_auxWord_videoType” for example, the target semantic attribute template will be determined in the maximum forward template matching algorithm as described below.

With nStart=0 and nLength=4, “cast_actVerb_auxWord_videoType” are matched with the respective semantic attribute templates in the set of semantic attribute templates; if there is no successful match, then one of the semantic attributes will be removed, that is, nLength will be decreased by 1, nLength=3 semantic attributes will be extracted starting with nStart=0, and “cast_actVerb_auxWord” will be matched with the respective semantic attribute templates in the set of semantic attribute templates; if there is still no successful match, then nLength will be further decreased by 1, nLength=2 semantic attributes will be extracted starting with nStart=0, and “cast_actVerb” will be matched with the respective semantic attribute templates in the set of semantic attribute templates; if there is a successful match, then the semantic attribute template corresponding to “cast_actVerb” will be determined as a target semantic attribute template; remaining “auxWord_videoType” will be matched with the respective semantic attribute templates in the set of semantic attribute templates; if there is no successful match, “auxWord” will be matched with the respective semantic attribute templates in the set of semantic attribute templates; if there is no successful match, then “auxWord” will be discarded, and “videoType” will be matched with the respective semantic attribute templates in the set of semantic attribute templates; and if there is a successful match, then the semantic attribute template corresponding to “videoType” will be determined as a target semantic attribute template, that is, two target semantic attribute templates are determined from the interactive sentence “Dehua LIU zhuyan de dianying”.

In another example, if the interactive sentence is “Querying costume movies starred by Xingchi ZHOU and before 1990's”, then semantic attributes will be annotated on a result of segmenting the interactive sentence into words, thus resulting in“Querying (Verb)/costume (Adjective)/movies (Multimedia type)/starred (Verb)/by (Preposition)/Xingchi ZHOU (Actor name)/and (Conjunction)/before (Preposition)/1990's (Date word and date unit)”, and target semantic attribute templates determined from the set semantic attribute templates according to the result of annotation as “̂_?actVerb_prep_cast_?$” and “̂_?beforeWord_dataWords_?$” corresponding to target grammar semantic information “Verb (starred)+prepposition+Actor name” and “Preposition+Date word and Date unit”.

The sentence can be matched with the set of semantic attribute templates to determine the target semantic attribute template, by matching the result of annotating the semantic attributes of the interactive sentence with the respective semantic attribute templates in the set of semantic attribute templates, or by matching the interactive sentence with grammar semantic information corresponding to the respective semantic attribute templates in the set of semantic attribute templates, although the embodiments of the disclosure will not be limited thereto.

The target semantic attribute template is determined from the set of semantic attribute templates, so that a phrase, with more complete meaning, including a plurality of consecutive words can be obtained according to the determined target semantic attribute template, and further a search for information can be made according to the phrase, for the purpose of improving the accuracy of the search for information.

The operation 104 is to determine a phrase including a plurality of consecutive words matching the target semantic attribute template as a single-query condition of the interactive sentence.

The single-query condition refers to a complete query limiting condition, for example, if there is a search sentence “Querying costume movies starred by Xingchi ZHOU and before 1990's”, then if a search for information is made using keywords, then keywords determined from the interactive sentence will include “Xingchi ZHOU”, “1990's”, “costume”, and “movies”, so that information retrieved according to these keywords includes only movies in 1990's, but no movies before 1990's, and information retrieved according to the keyword “Xingchi ZHOU” may include both movies starred by Xingchi ZHOU, and movies directed by Xingchi ZHOU, thus resulting in a loss of information, and low accuracy of the search for information. The target semantic attribute template is determined from the set of semantic attribute templates, so that a single-query condition can be obtained from the interactive sentence according to the determined semantic attribute template, and since the single-query condition is a phrase, including a plurality of consecutive words, obtained from the interactive sentence, i.e., a complete query definition condition, no information will be lost.

For example, if there is an interactive sentence “Querying costume movies starred by Xingchi ZHOU and before 1990's”, then target semantic attribute templates determined from the set of semantic attribute templates according to a result of annotation will include “̂_?actVerb_prep_cast_?$”, and “̂_?beforeWord_dataWords_?$”, and single-query conditions obtained from the search sentence according to the determined target semantic attribute templates will include “starred by Xingchi ZHOU” and “before 1990's”. It shall be noted that among single words for which no corresponding target semantic attribute templates are determined, e.g., “querying”, “by”, “and”, “costume”, and “movies”, words without any real meaning, e.g., “querying”, “by” and “and”, are discarded, and words with real meaning are determined respectively as single-query conditions including “costume” and “movies”; that is, the single-query condition can alternatively include a single word with real meaning instead of a phrase including a plurality of words, so that single-query conditions obtained from the interactive sentence “Querying costume movies starred by Xingchi ZHOU and before 1990's” include “starred by Xingchi ZHOU”, “before 1990's”, “costume”, and “movies”.

The phrases including a plurality of consecutive words matching the target semantic attribute templates are determined as the single-query conditions of the interactive sentence, that is, the single-query conditions which are the phrases including a plurality of consecutive words represent more complete semantic information than the keywords, so they can satisfy the search demand of the user as much as possible, thus avoiding a loss of information so as to improve the accuracy of the search for information.

In some embodiments of the disclosure, if there are at least two results of annotating semantic attributes on the result of segmenting the interactive sentence into words, then single-query conditions will be obtained respectively for the results of annotation, and subsequent searches will be made, and furthermore the single-query conditions of the at least two results will be de-duplicated, so that the single-query condition of the sentence will be determined, and further a subsequent search will be made according to the single-query condition.

For example, if the interactive sentence is “movies starred by Dehua LIU”, then results of annotating semantic attributes on a result of segmenting the interactive sentence into words will include “videoType_actVerb_prep_cast” and “videoType_actVerb_prep_singer”, and further “actVerb_prep_cast” and “actVerb_prep_singer” will be matched respectively with the set of semantic attribute templates; and if there is no successful match for “actVerb_prep_singer”, then the result of annotating semantic attributes including this combination of semantic attributes including “actVerb_prep_singer” will be removed, and if there is a successful match for “actVerb_prep_cast”, then a target semantic attribute template will be determined according to the result of annotating semantic attributes including this combination of semantic attributes including “actVerb_prep_cast”, and a single-query condition of the interactive sentence will be obtained.

The single-query conditions of the at least two results of annotation can be de-duplicated to thereby improve the accuracy of obtaining the single-query condition so as to further improve the accuracy of the search result.

The operation 105 is to parameterize the single-query condition under a preset rule to convert it into a structured query condition, where the preset rule is a parameterization rule corresponding to the target semantic attribute template.

Each semantic attribute template corresponds to a parameterization rule for parameterizing a corresponding single-query condition to convert the single-query condition into a structured query condition. A corresponding relationship between the parameterization rule and the semantic attribute template can be stored in the form of a list, or the identifier of the parameterization rule, and the identifier of the semantic attribute template can be stored in correspondence to each other in the form of a list as depicted in Table 2, where the identifier of the parameterization rule, and the identifier of the semantic attribute template can be different character strings or digital codes preset by a developer respectively, or character strings allocated automatically by the system or server, or information preset otherwise to identify different parameterization rules and semantic attribute templates, although the embodiments of the disclosure will not be limited to any particular identifiers of the parameterization rule and the semantic attribute template, and any particular schemes to preset those identifiers.

TABLE 2

| Semantic attribute template/ | Parameterization rule/ |
|---|---|
| Identifier of semantic | Identifier of |
| attribute template | parameterization rule |
| Template 1 (Identifier A) | Rule 1 (Identifier a) |
| Template 2 (Identifier B) | Rule 2 (Identifier b) |
| — | — |

The structured query condition includes condition parameters including at least one of the following categories of parameters: a subjective parameter, a predicate parameter, an object related attribute parameter, an object type parameter, a condition type parameter, an object data type parameter, and a weight parameter; and correspondingly the single-query condition is parameterized under the preset rule to be converted into the structured query condition, by assigning values to the condition parameters in the preset rule according to the single-query condition, and converting a result of the assignment into the structured query condition.

In some embodiments of the disclosure, the single-query condition is converted into the structured query condition according to the set of semantic attribute templates under such a production rule that is structured as Template→ConditionParameter→StructuredCondition, that is, if any one phrase or word matches any one semantic attribute template in the set of semantic attribute templates, then the phrase or the word will be determined as a single-query condition, and the single-query condition will be converted into a structured query condition. Here the generator rule can be interpreted as a combination of respective parameterization rules in sequence, where “ConditionParameter” represents respective parameters required for converting the single-query condition into the structured query condition: ConditionParameter={subject, verb, objectRelevant, objectType, conditionType, dataType, undirectWeight}, where the respective parameters will be described as follows:

“subject” represents a subject parameter, where if the single-query condition includes “movies”, or another word representing a movie or a teleplay, then “subject” will be the name of a field in a database of movies and teleplays;

“verb” represents a predict parameter, e.g., “>”, “is”, etc., where the structured query condition is subsequently converted into a formalized query language including “verb” which is an operator;

“objectRelevant” represents an object related attribute parameter, e.g., “cast”, “singer”, etc.;

“objectType” represents an object type parameter, where the value of “objectType” includes “attribute”, “position”, and “value”, and corresponding values of “objectRelevant” include a semantic attribute of an object word, the position of the object word, and the value of the object respectively;

“conditionType” represents a condition type parameter, where the values of “conditionType” include “where” and “order”, which respectively indicate that the single-query condition is a limiting condition or a sorting condition;

“dataType” represents a data type parameter of the object, where the values of “dataType” include “String” and “number”, which respectively indicate a character string and a number; and

“undirectWeight” represents a weight parameter which refers to a weight preset for a less rigid query condition.

With “ConditionParameter”, the single-query condition according with the template can be converted into “StructuredCondition”, and the structure of “StructuredCondition” can be defined as {subject, verb, objectList, conditionType, dataType, undirectWeight}.

For example, if there is a single-query condition “Dehua LIU/stars”, then such a preset rule corresponding to a semantic attribute template matching with the single-query condition will be obtained that may be {subject=“YANYUAN”, verb=like”, objectRelevant=“cast”, objectType=“attribute”, dataType=“where”, dataType=“string”, undirectWeight=“0.6”}, the single-query condition will be converted into such a structured query condition under the preset rule that is StructuredCondition: {subject=“yanyuan”, verb=“like”, objectList=“Dehua LIU”, dataType=“where”, dataType=“string”, undirectWeight=“0.6”}.

Here the weight parameter is determined according to a priority of the single-query condition; or the weight parameter is determined according to a popularity of the single-query condition. For example, if the interactive sentence includes two single-query conditions “Dehua LIU” and “Goodbye Mr. Loser”, if the weight parameter is determined according to the priority of the single-query condition, then if the priority of “Actor” is higher than the priority of “Movie name”, then the weight parameter corresponding to “Dehua LIU” will be more than the weight parameter corresponding to “Goodbye Mr. Loser”; and if the weight parameter is determined according to the popularity of the single-query condition, then if the popularity of “Goodbye Mr. Loser” is higher than the popularity of “Dehua LIU”, the weight parameter corresponding to “Goodbye Mr. Loser” will be more than the weight parameter corresponding to “Dehua LIU”.

The value of the weight parameter is preset so that if there are two single-query conditions, which are not associated with each other at all, in the interactive sentence, then a null search result will be avoided from being returned, and search results will be returned in proportion to the weight parameters corresponding to the respective single-query conditions. For example, if the weight parameter of “Dehua LIU” is 0.6, and the weight parameter of “Goodbye Mr. Loser” is 0.4, then search results related to “Dehua LIU” will account to 60% of all the returned search results, and search results related to “Goodbye Mr. Loser” will account to 40% of all the returned search results.

The single-query condition is converted into the structured query condition under the preset rule, and further a corresponding data list is searched according to the structured query condition, so that the accuracy of the search result can be further improved.

The operation 106 is to search for information according to the structured query condition.

If the embodiments of the disclosure are applied to the field of film and television, then a multimedia audio and video resource library will be searched; and it shall be noted that different data lists or databases can be searched in different scenarios or fields to which the method for searching for information according to the embodiments of the disclosure is applicable.

In some embodiments of the disclosure, the data list can be searched according to the structured query condition by converting the structured query condition into a query language corresponding to a query tool; and searching for information using the query language.

In some embodiments of the disclosure, the searching method above will be described in details taking SQL as a resulting structured query language. For example, given the structured query condition of the single-query condition “Dehua LIU/stars”, it can be known from dataType=“where” that the single-query condition is a query condition following the “WHERE” clause in an SQL sentence. The structure of the “where” clause is determined in the form of “Field name+Operator+‘% value %’” according to dataType=“string” and verb=“like”. “subject”, “verb”, and “objectList” are filled respectively into “Field name”, “Operator”, and “value”, thus resulting in the “WHERE” clause “YANYUAN like ‘% Dehua LIU %’”, which is appended to WHERE in the SQL sentence. As a result, the request of the user for “movies starred by Dehua LIU” can be converted into the SQL sentence “SELECT*FROM video_table WHERE YANYUAN like ‘% Dehua LIU %’ AND LEIXING like ‘% movies %’”.

A search is made according to the single-query condition obtained from the interactive sentence in the operation 105 and the operation 106; and of course, a search can alternatively be made otherwise according to the single-query condition obtained from the interactive sentence, but the embodiments of the disclosure will not be limited thereto.

In the method according to the embodiments of the disclosure, the interactive sentence for searching for information is received, the target semantic attribute template corresponding to the respective semantic attributes of a plurality of consecutive words in the interactive sentence is determined from the set of semantic attribute templates, and the single-query condition is obtained from the interactive sentence according to the determined target semantic attribute template. Since the single-query condition obtained from the interactive sentence is a phrase including a plurality of consecutive words in the interactive sentence, the single-query condition can represent more complete semantic information than the keywords, i.e., a complete query limiting condition, the search for information can be made according to the obtained single-query condition to thereby satisfy the search demand of the user as much as possible while avoiding the accuracy of the search from be degraded due to a loss of information; and furthermore each single-query condition can be converted into the structured search condition under the preset rule, and further the data list can be searched according to the structured search condition, to thereby improve the search speed and the search efficiency so as to further improve the accuracy of the search for information. It shall be noted that the single-query condition can be structured, and the structured search condition can be converted into the query language, respectively in other ways, but the embodiments of the disclosure will not be limited thereto.

It shall be noted that the method for searching for information according to the embodiments of the disclosure has been described above by way of an example in which the multimedia audio and video resource library is searched for a movie or teleplay resource, but the method for searching for information according to the embodiments of the disclosure will not be applicable only to the scenario of searching for a movie or teleplay, but will also be applicable to another scenario, e.g., of searching for information about a commodity, news, etc., where there may be different semantic attribute templates in the set of semantic attribute templates, and also different parameterization rules corresponding to the respective semantic attribute templates, in the different application scenarios, but either the application scenario to which the method for searching for information according to the embodiments of the disclosure is applicable, or the set of semantic attribute templates, and the parameterization rules, corresponding to the application scenario will not be limited thereto.

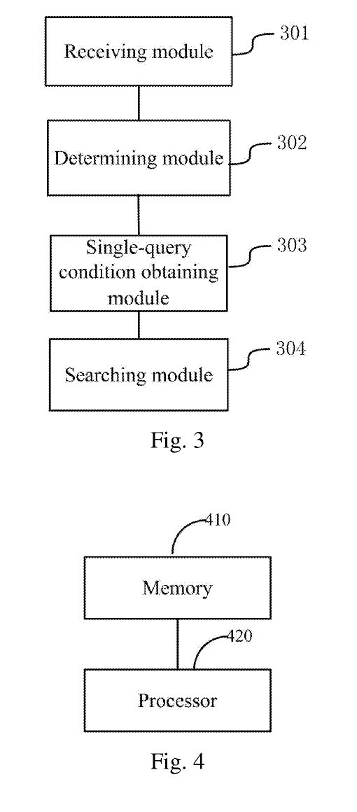

FIG. 3 is a block diagram of an apparatus for searching for information according to some embodiments of the disclosure. Referring to FIG. 3, the apparatus includes a receiving module 301, a determining module 302, a single-query condition obtaining module 303, and a searching module 304, where:

The receiving module 301 is configured to receive an interactive sentence for searching for information;

The determining module 302 is configured to determine a target semantic attribute template from a set of semantic attribute templates, where the target semantic attribute template is a semantic attribute template including semantic attributes corresponding respectively to semantic attributes of a plurality of consecutive words in the interactive sentence, and the set of semantic attribute templates includes at least one semantic attribute template including multiple semantic attributes in sequence or one semantic attribute;

A single-query condition obtaining module 303 is configured to determine a phrase including a plurality of consecutive words matching the target semantic attribute template as a single-query condition of the interactive sentence; and

A searching module 304 is configured to search for information according to the single-query condition.

In some embodiments of the disclosure, the searching module 304 is configured:

To parameterize the single-query condition under a preset rule to convert it into a structured query condition, where the preset rule is a parameterization rule corresponding to the target semantic attribute template; and

To search for information according to the structured query condition.

In some embodiments of the disclosure, the structured query condition includes condition parameters including at least one of the following categories of parameters: a subjective parameter, a predicate parameter, an object related attribute parameter, an object type parameter, a condition type parameter, an object data type parameter, and a weight parameter; and correspondingly the searching module 304 is configured:

To assign values to the condition parameters in the preset rule according to the single-query condition; and

To convert a result of the assignment into the structured query condition.

In some embodiments of the disclosure, the weight parameter is determined according to a priority of the single-query condition; or the weight parameter is determined according to a popularity of the single-query condition.

In some embodiments of the disclosure, the searching module 304 is configured:

To convert the structured query condition into a query language corresponding to a query tool; and

To search for information using the query language.

It shall be noted that the apparatus for searching for information according to the embodiments above of the disclosure has been described merely by way of an example where the apparatus is divided into the respective functional modules, but in a real application, the functions above can be allocated as needed to different functional modules for performance thereof, that is, the internal structure of the apparatus can be divided into different functional modules to perform all or a part of the functions as described above. Furthermore the technical idea of the apparatus for searching for information according to the embodiments above of the disclosure is the same as the method for searching for information according to the embodiments of the disclosure, so reference can be made to the embodiments of the method for an implementation of the apparatus, although a repeated description thereof will be omitted here.

Some embodiments of the disclosure provide another apparatus for searching for information as illustrated in FIG. 4, where the apparatus includes:

A memory 410, and at least one processor 420, where there is one processor illustrated in FIG. 4 as an example, the memory 410 is configured to store computer readable program codes, and the processor 420 is configured to execute the computer readable program codes to perform:

Receiving an interactive sentence for searching for information;

Determining a target semantic attribute template from a set of semantic attribute templates, where the target semantic attribute template is a semantic attribute template including semantic attributes corresponding respectively to semantic attributes of a plurality of consecutive words in the interactive sentence, and the set of semantic attribute templates includes at least one semantic attribute template including multiple semantic attributes in sequence or one semantic attribute;

Determining a phrase including a plurality of consecutive words matching the target semantic attribute template as a single-query condition of the interactive sentence; and

Searching for information according to the single-query condition.

In some embodiments of the disclosure, the processor 420 is further configured to execute the computer readable program codes to perform:

Parameterizing the single-query condition under a preset rule to convert it into a structured query condition, where the preset rule is a parameterization rule corresponding to the target semantic attribute template; and

Searching for information according to the structured query condition.

In some embodiments of the disclosure, the structured query condition includes condition parameters including at least one of the following categories of parameters: a subjective parameter, a predicate parameter, an object related attribute parameter, an object type parameter, a condition type parameter, an object data type parameter, and a weight parameter; and correspondingly the processor 420 is further configured to execute the computer readable program codes to perform:

Assigning values to the condition parameters in the preset rule according to the single-query condition; and

Converting a result of the assignment into the structured query condition.

In some embodiments of the disclosure, the weight parameter is determined according to a priority of the single-query condition; or the weight parameter is determined according to a popularity of the single-query condition.

In some embodiments of the disclosure, the processor 420 is further configured to execute the computer readable program codes to perform:

Converting the structured query condition into a query language corresponding to a query tool; and

Searching for information using the query language.

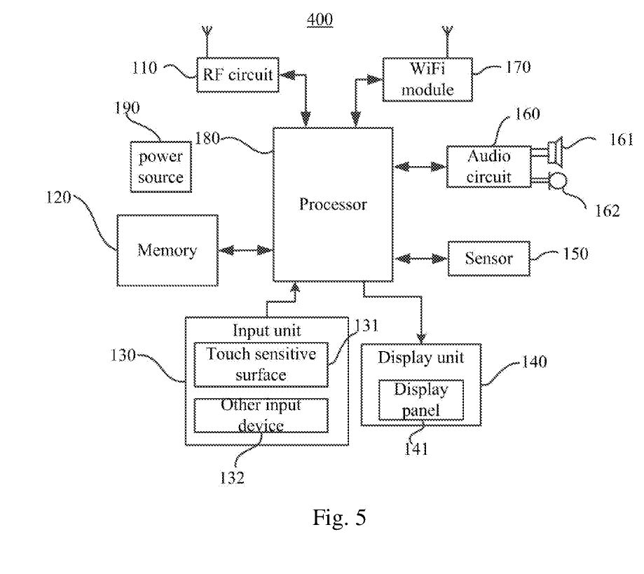

Some embodiments of the disclosure provide a terminal which can be configured to perform the method for searching for information according to the respective embodiments above of the disclosure. Referring to FIG. 5, the terminal 400 includes:

The terminal 400 can include a Radio Frequency (RF) circuit 110, a memory 120 including a computer readable storage medium, an input unit 130, a display unit 140, a sensor 150, an audio circuit 160, a Wireless Fidelity (WiFi) module 170, a processor 180 including at least one processing core, a power source 190, and other components. Those skilled in the art can appreciate that the structure of the terminal illustrated in FIG. 5 will not be intended to limit the terminal, but can include more or less components than those as illustrated, or have some of the components combined, or include different components arranged, where:

The RF circuit 110 can be configured to receive and transmit a signal in the course of receiving and transmitting information or in communication, by transferring downlink information of a base station to the at least one processor 180 for processing upon reception of the downlink information; and also transmitting uplink data to the base station. Typically the RF circuit 110 includes but will not be limited to an antenna, at least one amplifier, a tuner, one or more oscillators, a Subscriber Identifier Module (SIM) card, a transceiver, a coupler, a Low Noise Amplifier (LNA), a duplexer, etc. Moreover the RF circuit 110 can further communicate with a network and another device through wireless communication. The wireless communication can comply with any of communication standards or protocols including but not limited to the Global System of Mobile communication (GSM), the General Packet Radio Service (GPRS), the Code Division Multiple Access (CDMA), the Wideband Code Division Multiple Access (WCDMA), the Long Term Evolution (LTE), an e-mail, the Short Messaging Service (SMS), etc.

The memory 120 can be configured to store software programs and modules, and the processor 180 can be configured to run the software programs and modules stored in the memory to thereby perform various function applications and data processing. The memory 120 can generally include a program storage area and a data storage area, where an operating system, applications required for at least one function (e.g., an audio playing function, an image playing function, etc.), etc., can be stored in the program storage area; and data created for use of the terminal 400 (e.g., audio data, a phone book etc.), etc., can be stored in the data storage area. Additionally the memory 120 can include a high-speed random access memory, and can further include a nonvolatile memory, e.g., at least one magnetic-disk memory unit, a flash memory unit, or another volatile solid memory unit. Correspondingly the memory 120 can further include a memory controller configured to provide an access of the processor 180 and the input unit 130 to the memory 120.

The input unit 130 can be configured to receive input digit or character information, and to generate a keyboard, a mouse, a joystick, or an optical or track ball signal input related to user setting and function control. In some embodiments of the disclosure, the input unit 130 can include a touch sensitive surface 131 and another input unit 132. The touch sensitive surface 131, also referred to as a touch display screen or a touch control pad, can be configured to collect a touch operation by a user thereon or in proximity thereto (e.g., an operation by the user on or in proximity to the touch sensitive surface 131 using his or her finger, a stylus or any other appropriate object or attachment), and to drive a corresponding connected unit by preset program. Optionally the touch sensitive surface 131 can include two components which are a touch detection device and a touch controller, where the touch detection device detects the position of touching by the user, detects a signal as a result of the touch operation, and transfers the signal to the touch controller; and the touch controller receives the touch signal from the touch detection device, and converts it into coordinates of a touch point and further transfers them to the processor 180, and can receive and execute a command sent by the processor 180. Moreover the touch sensitive surface 131 can be embodied in various types of resistive, capacitive, infrared, surface sound wave and other types. The input unit can further include another input device 132 in addition to the touch sensitive surface 131. In some embodiments of the disclosure, the other input device 132 can include but will not be limited to one or more of a physical keyboard, functional keys (e.g., volume control buttons, a power-on or -off button, etc.), a track ball, a mouse, a joystick, etc.

The display unit 140 can be configured to display information input by the user or information provided to the user and various graphic user interfaces of the terminal 400, where these graphic user interfaces can be composed of graphics, texts, icons, videos and any combination thereof. The display unit 140 can include a display panel 141 which can be optionally configured in the form of a Liquid Crystal Display (LCD), an Organic Light-Emitting Diode (OLED) display, etc. Furthermore the touch sensitive surface 131 can overlie the display panel 141, and the touch sensitive surface 131, upon detection of the touch operation thereon or in proximity thereto, transfers it to the processor 180 to determine the type of the touch event, and thereafter the processor 180 provides a corresponding visual output on the display panel 141 according to the type of the touch event. Although the touch sensitive surface 131 and the display panel 141 are illustrated in FIG. 5 as two separate components to perform the input and output functions, the touch sensitive surface 131 and the display panel 141 can be integrated to perform the input and output functions in some embodiments of the disclosure.

The terminal 400 can further include at least one sensor 150, e.g., an optical sensor, a motion sensor, and other sensors. In some embodiments of the disclosure, the optical sensor can include an ambient light sensor and a proximity sensor, where the ambient light sensor can adjust the brightness of the display panel 141 according to the luminosity of ambient light rays, and the proximity sensor can power off the display panel 141 and/or a backlight when the terminal 400 moves in proximity to an ear. A gravity acceleration sensor which is a motion sensor can detect the magnitudes of accelerations in respective directions (typically three axes), can detect the magnitude and the direction of gravity when the sensor is stationary, and can be configured to perform applications of identifying the posture of a handset (e.g., switching between landscape and portrait modes, relevant games, calibration of the posture of a magnetometer, etc.), a relevant function of identifying vibration (e.g., a pedometer, a knock, etc.), etc.; and the terminal 400 can be further configured with a gyroscope, a barometer, a hygrometer, a thermometer, an infrared sensor and other sensors, although a repeated description of these components will be omitted here.

The audio circuit 160, the speaker 161, and the audio transducer 162 can provide an audio interface between the user and the terminal 400. The audio circuit 160 can transmit the received electrical signal converted from audio data to the speaker 161, which converts the electrical signal into a sound signal, and outputs the sound signal; and on the other hand, the audio transducer 162 can convert a collected sound signal into an electrical signal, the electrical signal can be received by the audio circuit 160 and then converted into audio data, the audio data can be further output to the processor 180 for processing, and the processor 180 can further transmit the audio data to another terminal through the RF circuit 110, or output the audio data to the memory 120 for further processing. The audio circuit 160 may further include an earplug jack configured to provide communication between earpieces and the terminal 400.

The WiFi falls into the category of short-range wireless transmission technologies, and the terminal 400 can assist the user in receiving and transmitting an e-mail, browsing a webpage, accessing streaming media, etc., through the WiFi module 170 by which the user is provided with a wireless access to the broadband Internet. Although the WiFi module 170 is illustrated in FIG. 5, it can be appreciated that it may not be necessarily required for the terminal 400, but can be omitted as desired without departing from the scope of the disclosure.

The processor 180 is a control component of the terminal 400, has the respective components connected by various interfaces and lines, and runs or executes the software programs and/or modules stored in the memory 120, and invokes the data stored in the memory 120 to perform the various functions of the terminal 400 and process the data to thereby manage and control the terminal as a whole. In some embodiments of the disclosure, the processor 180 can include one or more processing cores; and in some embodiments of the disclosure, the processor 180 can be integrated with an application processor and a modem processor, where the application processor generally handles the operating system, the user interfaces, the applications, etc., and the modem processor generally handles wireless communication. As can be appreciated, the modem processor above may not be integrated into the processor 180.

The terminal 400 further includes a power source 190 (e.g., a battery) powering the respective components, and in some embodiments of the disclosure, the power source 190 can be logically connected with the processor 180 through a power management system to thereby perform charging and discharging management, power consumption management, etc., through the power management system. The power source 190 can further include one or more DC or AC power sources, recharging systems, power source failure detection circuits, power source transformers or inverters, power source status indicators, and any other components.

Although not illustrated, the terminal 400 can further include a webcam, a Bluetooth module, etc., though a repeated description thereof will be omitted here. In some embodiments of the disclosure, the display unit of the terminal can be a touch screen display, and the terminal can further include a memory, and one or more programs stored in the memory, and configured to be executed by at least one processor, where the one or more programs include instructions for performing the operations of:

Receiving an interactive sentence for searching for information;

Determining a target semantic attribute template from a set of semantic attribute templates, where the target semantic attribute template is a semantic attribute template including semantic attributes corresponding respectively to semantic attributes of a plurality of consecutive words in the interactive sentence, and the set of semantic attribute templates includes at least one semantic attribute template including multiple semantic attributes in sequence or one semantic attribute;

Determining a phrase including a plurality of consecutive words matching the target semantic attribute template as a single-query condition of the interactive sentence; and

Searching for information according to the single-query condition.

Some embodiments of the disclosure further provide a nonvolatile computer storage medium storing computer executable instructions configured:

To receive an interactive sentence for searching for information;

To determine a target semantic attribute template from a set of semantic attribute templates, where the target semantic attribute template is a semantic attribute template including semantic attributes corresponding respectively to semantic attributes of a plurality of consecutive words in the interactive sentence, and the set of semantic attribute templates includes at least one semantic attribute template including multiple semantic attributes in sequence or one semantic attribute;

To determine a phrase including a plurality of consecutive words matching the target semantic attribute template as a single-query condition of the interactive sentence; and

To search for information according to the single-query condition.

In some embodiments of the disclosure, the computer executable instructions are further configured:

To parameterize the single-query condition under a preset rule to convert it into a structured query condition, where the preset rule is a parameterization rule corresponding to the target semantic attribute template; and

To search for information according to the structured query condition.

In some embodiments of the disclosure, the structured query condition includes condition parameters including at least one of the following categories of parameters: a subjective parameter, a predicate parameter, an object related attribute parameter, an object type parameter, a condition type parameter, an object data type parameter, and a weight parameter; and correspondingly the computer executable instructions are further configured:

To assign values to the condition parameters in the preset rule according to the single-query condition; and

To convert a result of the assignment into the structured query condition.

In some embodiments of the disclosure, the weight parameter is determined according to a priority of the single-query condition; or the weight parameter is determined according to a popularity of the single-query condition.

In some embodiments of the disclosure, the computer executable instructions are further configured:

To convert the structured query condition into a query language corresponding to a query tool; and

To search for information using the query language.

Those ordinarily skilled in the art can appreciate that the embodiments above of the disclosure can be implemented in hardware, or in program instructing relevant hardware, where the program can be stored in a computer readable storage medium, which can be a read-only memory, a magnetic disk, an optical disc, etc.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. An apparatus for searching for information, the apparatus comprising: a memory, and at least one processor, wherein the memory is configured to store computer readable program codes, and the processor is configured to execute the computer readable program codes to perform:
receiving an interactive sentence for searching for information;
determining a target semantic attribute template from a set of semantic attribute templates, wherein the target semantic attribute template is a semantic attribute template comprising semantic attributes corresponding respectively to semantic attributes of a plurality of consecutive words in the interactive sentence, and the set of semantic attribute templates comprises at least one semantic attribute template comprising multiple semantic attributes in sequence or one semantic attribute;
determining a phrase comprising a plurality of consecutive words matching the target semantic attribute template as a single-query condition of the interactive sentence; and
searching for information according to the single-query condition.

2. The apparatus according to claim 1, wherein the processor is further configured to execute the computer readable program codes to perform:
parameterizing the single-query condition under a preset rule to convert it into a structured query condition, wherein the preset rule is a parameterization rule corresponding to the target semantic attribute template; and
searching for information according to the structured query condition.

3. The apparatus according to claim 2, wherein the structured query condition comprises condition parameters comprising at least one of following categories of parameters: a subjective parameter, a predicate parameter, an object related attribute parameter, an object type parameter, a condition type parameter, an object data type parameter, and a weight parameter; and the processor is further configured to execute the computer readable program codes to perform:
assigning values to condition parameters in the preset rule according to the single-query condition; and
converting a result of the assignment into the structured query condition.

4. The apparatus according to claim 3, wherein the weight parameter is determined according to a priority of the single-query condition; or the weight parameter is determined according to a popularity of the single-query condition.

5. The apparatus according to claim 2, wherein the processor is further configured to execute the computer readable program codes to perform:
converting the structured query condition into a query language corresponding to a query tool; and
searching for information using the query language.

6. A method for searching for information, the method comprising:
receiving an interactive sentence for searching for information;
determining a target semantic attribute template from a set of semantic attribute templates, wherein the target semantic attribute template is a semantic attribute template comprising semantic attributes corresponding respectively to semantic attributes of a plurality of consecutive words in the interactive sentence, and the set of semantic attribute templates comprises at least one semantic attribute template comprising multiple semantic attributes in sequence or one semantic attribute;
determining a phrase comprising a plurality of consecutive words matching the target semantic attribute template as a single-query condition of the interactive sentence; and
searching for information according to the single-query condition.

7. The method according to claim 6, wherein the searching for information according to the single-query condition comprises:
parameterizing the single-query condition under a preset rule to convert it into a structured query condition, wherein the preset rule is a parameterization rule corresponding to the target semantic attribute template; and
searching for information according to the structured query condition.

8. The method according to claim 7, wherein the structured query condition comprises condition parameters comprising at least one of following categories of parameters: a subjective parameter, a predicate parameter, an object related attribute parameter, an object type parameter, a condition type parameter, an object data type parameter, and a weight parameter; and the parameterizing the single-query condition under the preset rule to convert it into the structured query condition comprises:
assigning values to condition parameters in the preset rule according to the single-query condition; and
converting a result of the assignment into the structured query condition.

9. The method according to claim 8, wherein the weight parameter is determined according to a priority of the single-query condition; or the weight parameter is determined according to a popularity of the single-query condition.

10. The method according to claim 7, wherein the searching for information according to the structured query condition comprises:
converting the structured query condition into a query language corresponding to a query tool; and
searching for information using the query language.

11. A nonvolatile computer storage medium, storing computer executable instructions configured:
to receive an interactive sentence for searching for information;
to determine a target semantic attribute template from a set of semantic attribute templates, wherein the target semantic attribute template is a semantic attribute template comprising semantic attributes corresponding respectively to semantic attributes of a plurality of consecutive words in the interactive sentence, and the set of semantic attribute templates comprises at least one semantic attribute template comprising multiple semantic attributes in sequence or one semantic attribute;
to determine a phrase comprising a plurality of consecutive words matching the target semantic attribute template as a single-query condition of the interactive sentence; and
to search for information according to the single-query condition.

12. The computer storage medium according to claim 11, wherein the computer executable instructions are further configured:
to parameterize the single-query condition under a preset rule to convert it into a structured query condition, wherein the preset rule is a parameterization rule corresponding to the target semantic attribute template; and
to search for information according to the structured query condition.

13. The computer storage medium according to claim 12, wherein the structured query condition comprises condition parameters comprising at least one of following categories of parameters: a subjective parameter, a predicate parameter, an object related attribute parameter, an object type parameter, a condition type parameter, an object data type parameter, and a weight parameter; and the computer executable instructions are further configured:
to assign values to condition parameters in the preset rule according to the single-query condition; and
to convert a result of the assignment into the structured query condition.

14. The computer storage medium according to claim 13, wherein the weight parameter is determined according to a priority of the single-query condition; or the weight parameter is determined according to a popularity of the single-query condition.

15. The computer storage medium according to claim 12, wherein the computer executable instructions are further configured:
to convert the structured query condition into a query language corresponding to a query tool; and
to search for information using the query language.
